(19) United States
(12) Patent Application Publication
(10) Pub. No.: US 2025/0373713 A1
(43) Pub. Date: Dec. 4, 2025

(54) PPDU Extension

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Kazi Mohammed Saidul Huq, Herndon, VA (US); Serhat Erkucuk, Reston, VA (US)

(73) Assignee: Ofinno, LLC, Reston, VA (US)

(21) Appl. No.: 19/299,957

(22) Filed: Aug. 14, 2025

Related U.S. Application Data
(63) Continuation of application No. PCT/US2024/015942, filed on Feb. 15, 2024.
(60) Provisional application No. 63/446,053, filed on Feb. 16, 2023.

(51) Int. Cl. H04L 69/22; H04W 80/02

(52) U.S. Cl. CPC H04L 69/22; H04W 80/02

(57) ABSTRACT

A first station (STA) receives from a second STA, while transmitting a first frame to the second STA, a second frame indicating a payload unit, of the first frame, received in error by the second STA. The first STA transmits to the second STA, an extension of the first frame comprising the payload unit received in error by the second STA.

### CROSS-REFERENCE TO RELATED APPLICATIONS

This application is a continuation of International Application No. PCT/US2024/015942, filed Feb. 15, 2024, which claims the benefit of U.S. Provisional Application No. 63/446,053, filed Feb. 16, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3A illustrates an example of Physical Layer Protocol Data Unit (PPDU) which may be used by a device to transmit on a wireless medium.

FIG. 3B illustrates another example of PPDU which may be used by a device to transmit on a wireless medium.

FIG. 4 is an example that illustrates wireless medium access in a Wireless Local Area Network (WLAN).

FIG. 5 is an example that illustrates a multi-link acknowledgement operation.

FIG. 6 is an example that illustrates an early acknowledgment operation.

FIG. 7 is an example that illustrates a full-duplex acknowledgement operation.

FIG. 8 is an example that illustrates an example operation according to an embodiment.

FIG. 9 is an example that illustrates another example operation according to an embodiment.

FIG. 10 is an example that illustrates another example operation according to an embodiment.

FIG. 11 illustrates an example process according to an embodiment.

FIG. 12 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

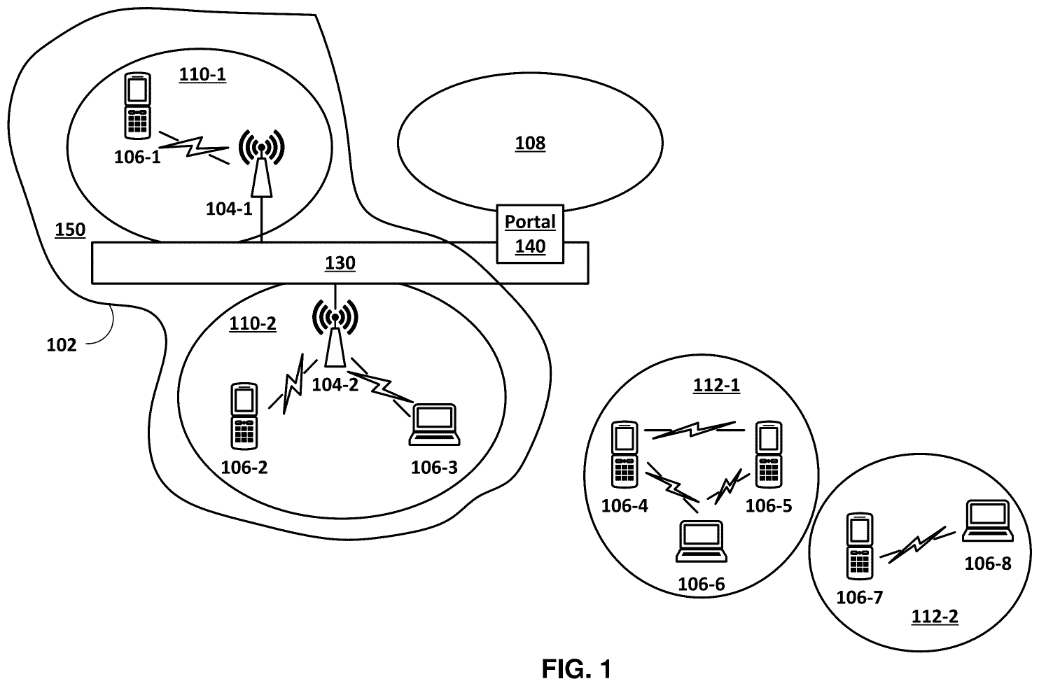

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz. In another example, PPDUs conforming to the IEEE 802.11ad and/or 802.11ay standard amendments may be transmitted over the 60 GHz band, which may be divided into multiple 2.16 GHz channels. The PPDUs may be transmitted over a physical channel having a minimum bandwidth of 2.16 GHz. Larger channels may be formed through channel bonding. For example, PPDUs may be transmitted over physical channels having bandwidths of 4.32 GHz, 6.48 GHz, 8.64 GHz by bonding together multiple 2.16 GHz.

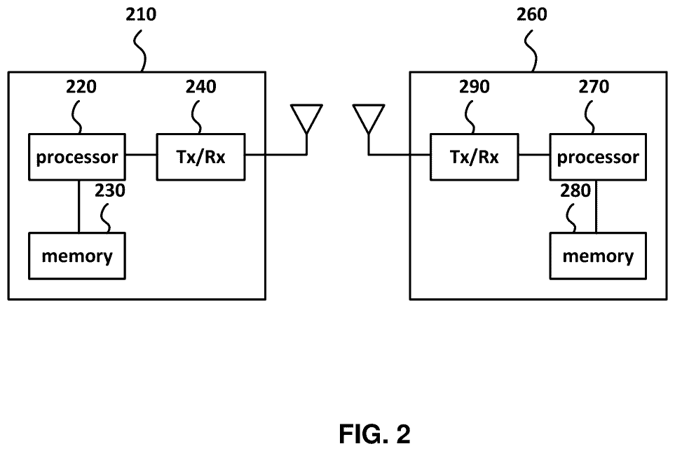

FIG. 2 is a block diagram illustrating example implementations of a STA 210 and an AP 260.

As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

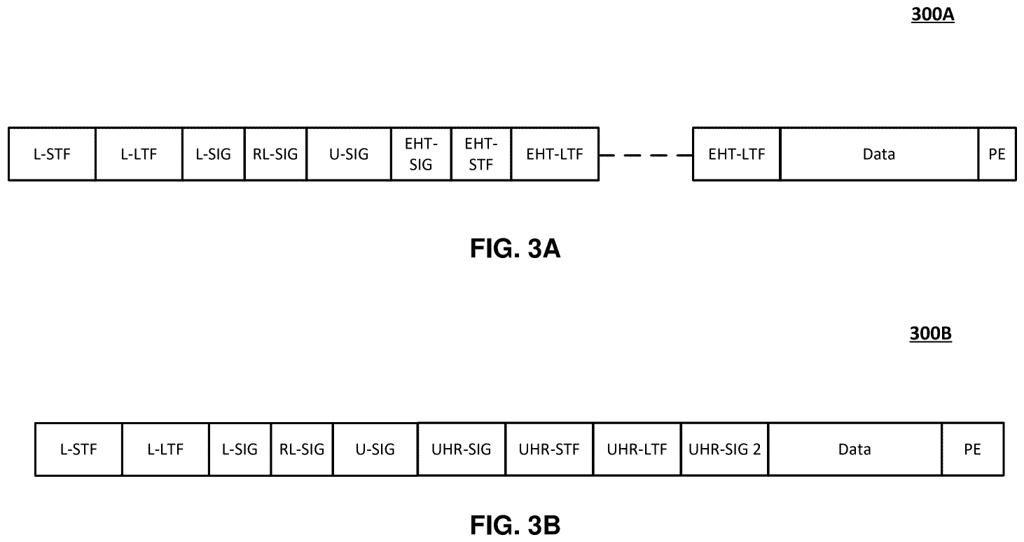

FIG. 3A illustrates an example PPDU 300A which may be used by a device (STA or AP) to transmit on a wireless medium. PPDU 300A may be an Extremely High Throughput (EHT) PPDU which may be used by devices conforming to the IEEE 802.11be standard amendment. Such devices may operate in the 2.4, 5, and 6 GHz bands. In an implementation, PPDU 300A may be transmitted over a bandwidth of up to 320 MHz. PPDU 300A may be used by a device for both single user (SU) and multi-user (MU) transmissions.

As shown in FIG. 3A, PPDU 300A includes an non-HT Short Training field (L-STF), a non-HT Long Training field (L-LTF), a non-High-Throughput (non-HT) Signal field (L-SIG), a non-HT Repeated Signal field (RL-SIG), a Universal Signal field (U-SIG), an EHT Signal Field B (EHT-SIG-B), an EHT Short Training Field (EHT-STF) field, one or more EHT Long Training field (EHT-LTF), a Data field, and a Packet Extension (PE) field.

The L-STF is used by a receiver of PPDU 300A to synchronize with the carrier frequency and frame timing of a transmitter of PPDU 300A and to adjust the receiver signal gain.

The L-LTF is used by the receiver of PPDU 300A to estimate channel coefficients in order to equalize the channel response (e.g., amplitude and phase distortion) in both Signal fields (L-SIG, RL-SIG, U-SIG, EHT-SIG) and the Data field of PPDU 300A.

The L-SIG and RL-SIG contain parameters needed to demodulate the Data field. The L-SIG may be equalized using the channel coefficients estimated using the L-LTF and demodulated to obtain the demodulation parameters of the Data field.

The U-SIG ensures forward compatibility of PPDU 300A. This means that any future PPDUs that are backward compatible to IEEE 802.11be will contain the same U-SIG field and interpretation. Because of this, IEEE 802.11be conforming devices will be able to understand at least in part a PPDU developed in a future amendment, provided those amendments contain the U-SIG field as well.

The EHT-SIG contains indications per STA of RU allocations. A receiving STA may use the indications in the EHT-SIG to locate its payload in the Data field of PPDU 300A.

The L-SIG, RL-SIG, U-SIG, and EHT-SIG fields may be considered as a PHY Header of PPDU 300A.

The EHT-STF and the one or more EHT-LTFs are used by the receiver of PPDU 300A to estimate channel coefficients in order to equalize the channel response (e.g., amplitude and phase distortion) in the Data field of PPDU 300A.

The Data field contains one or more payloads carried by PPDU 300A. The one or more payloads may comprise MPDUs.

The PE field is an extension of PPDU 300A designed to give the receiver of PPDU 300A sufficient time to respond after receiving PPDU 300A.

FIG. 3B illustrates an example PPDU 300B which may be used by a device (STA or AP) to transmit on a wireless medium. Example PPDU 300B is provided for the purpose of illustration only and is not limiting to embodiments of the present disclosure.

As shown in FIG. 3B, PPDU 300B includes an L-STF, an L-LTF, an L-SIG, an RL-SIG, a Universal Signal field (U-SIG), an UHR Signal Field (UHR-SIG), an UHR Short Training Field (UHR-STF) field, one or more UHR Long Training field (UHR-LTF), an UHR Signal Field 2 (UHR-SIG 2), a Data field, and a PE field.

The U-SIG ensures forward compatibility of PPDU 300B. This means that any future PPDUs that are backward compatible to IEEE 802.11be will contain the same U-SIG field and interpretation. Because of this, IEEE 802.11be conforming devices will be able to understand at least in part a PPDU developed in a future amendment, provided those amendments contain the U-SIG field as well.

The UHR-SIG contains indications per STA of RU allocations. A receiving STA may use the indications in the UHR-SIG to locate its payload in the Data field of PPDU 300B.

The UHR-STF and the one or more UHR-LTFs are used by the receiver of PPDU 300B to estimate channel coefficients in order to equalize the channel response (e.g., amplitude and phase distortion) in the Data field of PPDU 300B.

The UHR-SIG 2 contains indications for multi user (MU) multiple input multiple out (MU-MIMO) applications. The UHR-SIG 2 field may also be used for other indications related to the Data field, e.g., modulation and coding scheme (MCS), data type, length, etc.

The L-SIG, RL-SIG, U-SIG, UHR-SIG, and UHR-SIG 2 fields may be considered a PHY Header of PPDU 300B.

The Data field contains one or more payloads carried by PPDU 300B. The bits to be transmitted may be padded with zeros, if necessary, scrambled, encoded, and modulated.

The PE field is an extension of PPDU 300B designed to give the receiver of PPDU 300B sufficient time to respond after receiving PPDU 300B.

Current and future IEEE 802.11 standards are designed to operate at different frequency bands, such as sub-1 GHz, TV Whitespace (TVWS), 2.4 GHz, 5 GHz, 6 GHz, 45 GHz (China mmWave), 60 GHz, and Infrared. During the development of the IEEE 802.11be standard amendment, multi-link operation (MLO) was developed for the sub-7 GHz bands (2.4 GHz, 5 GHz, and 6 GHz bands), allowing an AP conforming to the IEEE 802.11be standard amendment to support more than one sub-7 GHz band. It is envisioned that next generation systems will support MLO over more bands, including “lightly” licensed bands.

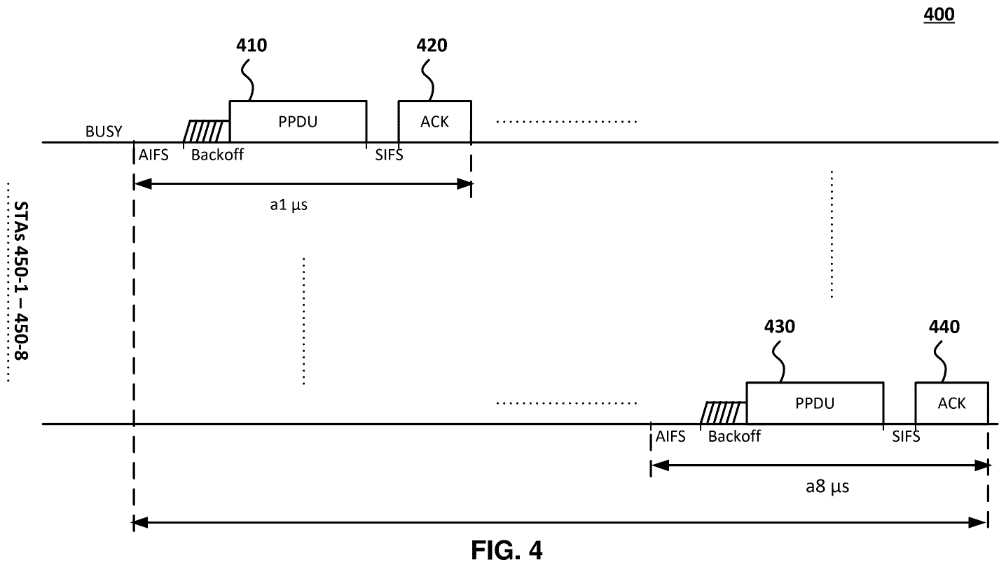

FIG. 4 is an example 400 that illustrates wireless medium access by a plurality of STAs in a WLAN. As shown in FIG. 4, example 400 includes 8 STAs (450-1, . . . , 8) that are contending for the medium using Enhanced Distributed Channel Access (EDCA).

EDCA is a listen-before-talk access mechanism that allows exactly one STA to access a channel and to transmit a PPDU in a given time slot. Before transmission using EDCA, a STA listens to the channel for a minimum of an Arbitration Interframe Space (AIFS) duration to determine whether the channel state is IDLE. This listening time for determining whether the channel is IDLE may be followed by one or more backoff slots before the STA attempts to transmit over the channel. The number of backoff slots is chosen randomly by the STA. This reduces the probability of multiple STAs attempting to transmit at the same time, which would result in a packet detect error. If the PPDU transmitted by the STA is received successfully, for example by an AP (not shown in the figure), the AP may respond with an acknowledgement (ACK) frame after a Short Interframe Space (SIFS) duration of receiving the PPDU.

In example 400, STAs 450-1, . . . , 8 access the channel one by one using EDCA. For example, first, STA 450-1 transmits a PPDU 410 and receives an ACK or NACK (negative acknowledgment) frame 420 from an AP. As shown in FIG. 4, the total duration of channel access by STA 450-1 includes an AIFS duration, a backoff period, the transmission time of PPDU 410, a SIFS duration, and the transmission time of ACK/NACK 420. This total duration of channel access by STA 450-1 may be expressed a1 μs. Similarly, STAs 450-2 to 450-7 each accesses the channel using EDCA and receives a corresponding ACK or NACK frame from the AP. The total duration of channel access by STAs 450-2 to 250- 7 may be expressed as a2 μs-a7 μs respectively. Finally, STA 450-8 transmits a PPDU 430 and receives an ACK or NACK frame 440 within a total duration of channel access of a8 μs. Hence, channel access by STAs 450-1, . . . , 8 requires a cumulative duration T_SU μs=a1 μs+. . . +a8 μs. This T_SU us duration represents an average latency of channel access for each STA when 8 STAs are actively accessing the channel as in example 400.

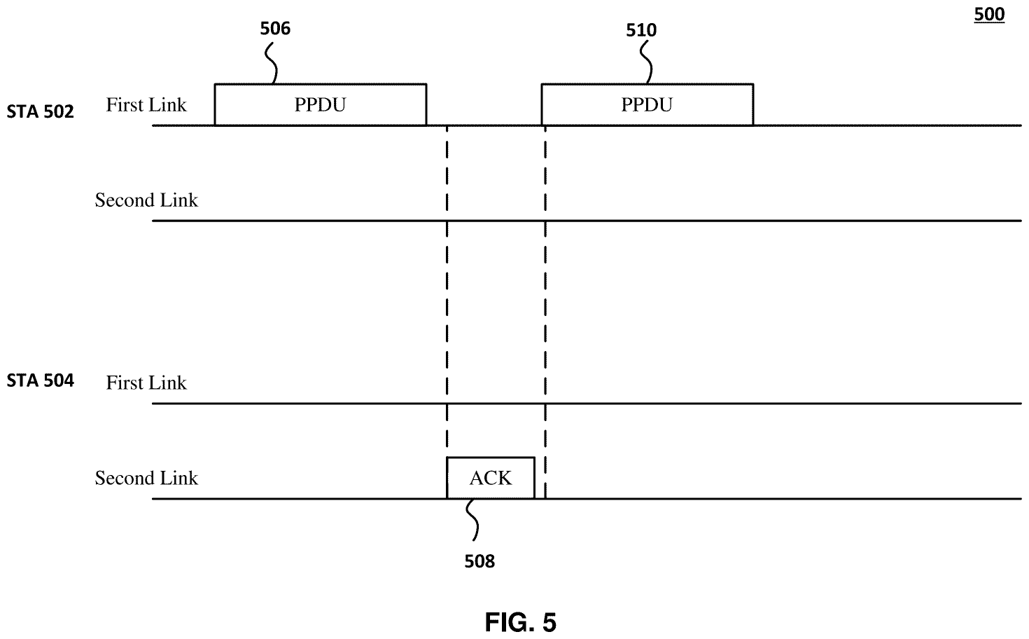

To enhance channel access delay, it has been proposed to use a separate link to transmit the ACK/NACK frames in response to the transmitted PPDUs. For example, where the PPDU transmission occurs over a 2.4 GHz link, the ACK for the PPDU transmission may be transmitted over a 5 GHz link. Such an ACK/NACK may be referred to as a cross-link acknowledgment (XACK). FIG. 5 illustrates an example 500 of such operation. As shown in FIG. 5, example 500 includes a STA 502 and a STA 504. STA 502 may transmit a PPDU 506 to STA 504 on a first link. In an example, STA 504 may receive a part of PPDU 506 in error. In response, STA 504 may transmit an ACK frame 508 to STA 502 on a second link (different from the first link).

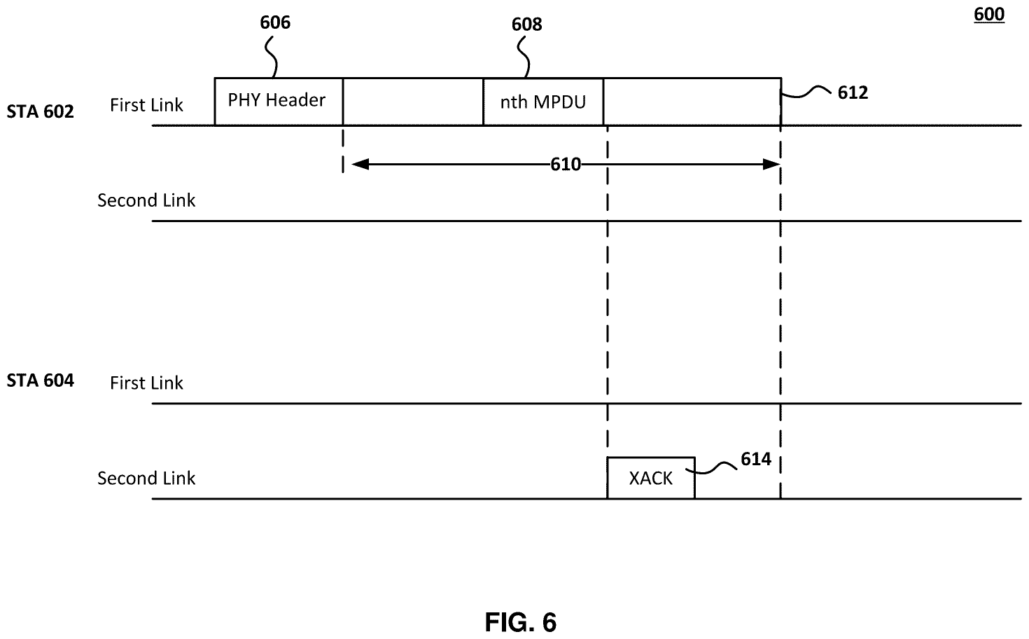

According to existing operation, STA 504 must wait until an end of reception of PPDU 506 before it may transmit ACK frame 508 to STA 502 on the second link. As a result, STA 502 must wait until the end of transmission of PPDU 506 before it may re-transmit PPDU 506 as PPDU 510 due to the erroneous reception. Such operation may result in an unnecessary delay for STA 504 to receive PPDU 506. To address this problem, it has been proposed to transmit an ACK frame during the transmission of the PPDU that the ACK frame acknowledges. FIG. 6 is an example 600 that illustrates such an operation. As shown in FIG. 6, example 600 includes a STA 602 and a STA 604. STAs 602 and 604 may be communicatively coupled by a first link and a second link. The first and second link may correspond to different frequency bands (e.g., 2.4 GHz, 5 GHz, 60 GHz, etc.). STAs 602 and 604 may each comprise a STA or an AP.

In example 600, STA 602 is transmitting a PPDU 612 to STA 604 on the first link. PPDU 612 may include a preamble (not shown in FIG. 6), a PHY header 606, and a data field 610. PPDU 612 may be, for example, an EHT PPDU as illustrated by example PPDU 300A or a UHR PPDU as illustrated by example PPDU 300B described above.

In an embodiment, as STA 602 transmits PPDU 612 over the first link, STA 602 may monitor the second link. Specifically, STA 602 may monitor the second link for an XACK frame from STA 604.

As STA 604 receives data field 610 of PPDU 612, STA 604 may be configured to determine whether an error is present in each received MPDU of data field 610 of PPDU 612. Specifically, as an MPDU of PPDU 612 is received, STA 604 may check the MPDU for errors. If no error is detected in the MPDU, STA 604 may check whether the MPDU is the last MPDU of PPDU 612. If the MPDU is the last MPDU of PPDU 612, STA 604 may be configured to acknowledge PPDU 612 by sending an acknowledgment on the first or second link. Otherwise, if the MPDU is not the last MPDU of PPDU 612, STA 604 may proceed to decoding and checking the next MPDU. If an error is detected in the MPDU, STA 604 may be configured to transmit an XACK frame on the second link indicating the error in the MPDU to STA 602.

In example 600, STA 604 may detect an error in an nth MPDU 608 of data field 610 of PPDU 612. As such, STA 604 transmits an XACK frame 614 on the second link to STA 602. After determining that the nth MPDU 608 is not the last MPDU in data field 610 of PPDU 612, STA 604 may proceed to decode the next received MPDU of data field 610 of PPDU 612. STA 602 monitoring the second link receives XACK frame 614 from STA 604. On receiving XACK frame 614, STA 602 decodes XACK frame 614 and determines that XACK frame 614 indicates an error in the nth MPDU 608 of PPDU 612.

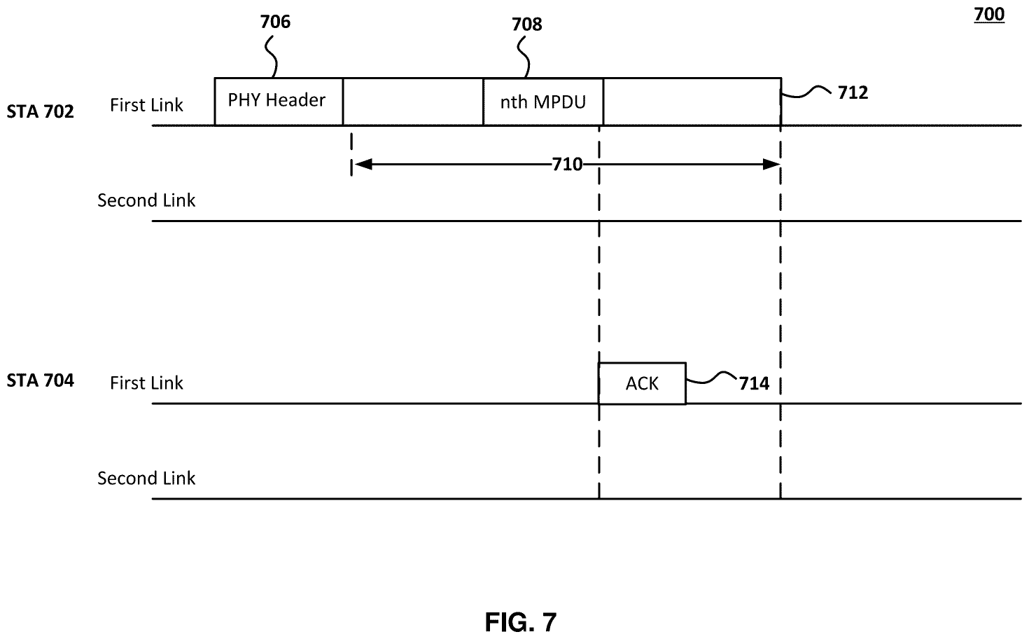

FIG. 7 is an example 700 that illustrates early acknowledgment operation in a full-duplex environment. As shown in FIG. 7, example 700 includes a STA 702 and a STA 704. STAs 702 and 704 may be communicatively coupled by a first link and, optionally, a second link. The first and second link may correspond to different frequency bands (e.g., 2.4 GHz, 5 GHz, 60 GHz, etc.). STAs 702 and 704 may each comprise a STA or an AP. In example 700, it assumed that STAs 702 and 704 support full-duplex communication on a given link (e.g., the first link). As such, STAs 702 and 704 may each transmit and receive simultaneously on the link.

In example 700, STA 702 is transmitting a PPDU 712 to STA 704 on the first link. PPDU 712 may include a preamble (not shown in FIG. 7), a PHY header 706, and a data field 710. PPDU 712 may be, for example, an EHT PPDU as illustrated by example PPDU 300A or a UHR PPDU as illustrated by example PPDU 300B described above.

In an embodiment, as STA 702 transmits PPDU 712 over the first link, STA 702 may monitor the same link for frames from STA 704. Specifically, STA 702 may monitor the first link for an ACK frame from STA 704.

As STA 704 receives data field 710 of PPDU 712, STA 704 may be configured to determine whether an error is present in each received MPDU of data field 710 of PPDU 712. Specifically, as an MPDU of PPDU 712 is received, STA 704 may check the MPDU for errors. If no error is detected in the MPDU, STA 704 may check whether the MPDU is the last MPDU of PPDU 712. If the MPDU is the last MPDU of PPDU 712, STA 704 may be configured to acknowledge PPDU 712 by sending an acknowledgment on the first link. Otherwise, if the MPDU is not the last MPDU of PPDU 712, STA 704 may proceed to decoding and checking the next MPDU. If an error is detected in the MPDU, STA 704 may be configured to transmit an ACK frame on the first link indicating the error in the MPDU to STA 702.

In example 700, STA 704 may detect an error in an nth MPDU 708 of data field 710 of PPDU 712. As such, STA 704 transmits an ACK frame 714 on the first link to STA 702. After determining that the nth MPDU 708 is not the last MPDU in data field 710 of PPDU 712, STA 704 may proceed to decode the next received MPDU of data field 710 of PPDU 712. STA 702 monitoring the first link receives ACK frame 714 from STA 704. On receiving ACK frame 714, STA 702 decodes ACK frame 714 and determines that ACK frame 714 indicates an error in the nth MPDU 708 of PPDU 712.

According to existing operation, in examples 600 and 700 described above, upon receiving XACK frame 614 or ACK frame 714 indicating an error in an MPDU of the PPDU being transmitted, the transmitting STA (e.g., STA 602 or STA 702) must wait until the end of transmission of the PPDU before re-transmitting the MPDU in error. Further, the MPDU re-transmission is performed by transmitting a subsequent PPDU with a full preamble and PHY header. Moreover, when XACK frame 614 or ACK frame 714 indicate more than one MPDU in error, the MPDUs in error are re-transmitted in the subsequent PPDU in the same order as in the initial PPDU. This behavior may increase MPDU re-transmission latency and overhead and may be particularly unsuitable for latency sensitive traffic, which may require immediate re- transmission to remain useable by the receiving STA. Further, the existing behavior may not leverage the full capabilities of the transmitting STA.

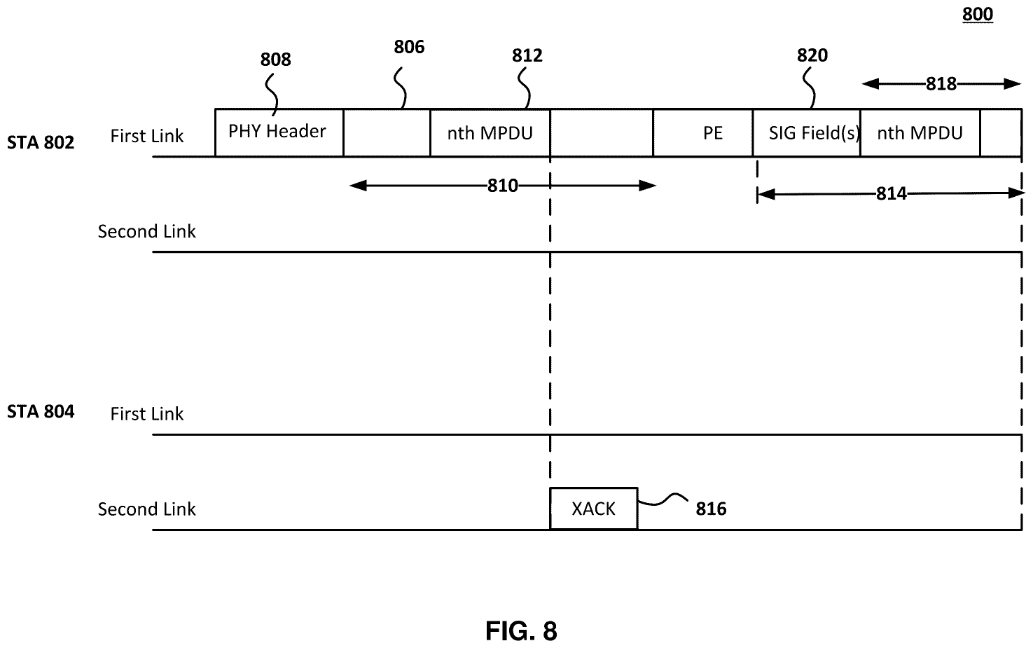

FIG. 8 illustrates an example 800 that illustrates an example operation according to an embodiment. As shown in FIG. 8, example 800 includes a STA 802 and a STA 804. STAs 802 and 804 may be communicatively coupled by a first link and a second link. The first and second links may correspond to different frequency bands (e.g., 2.4 GHz, 5 GHz, 60 GHz, etc.). STAs 802 and 804 may each comprise a STA or an AP.

In example 800, STA 802 is transmitting a PPDU 806 to STA 804. PPDU 806 may include a preamble (not shown in FIG. 8), a PHY header 808, a data field 810, and optionally a PE field. PPDU 806 may be, for example, an EHT PPDU as illustrated by example PPDU 300A or a UHR PPDU as illustrated by example PPDU 300B described above.

STA 804 may receive PPDU 806 over the first link and may first decode PHY header 808 of PPDU 806. In an embodiment, STA 804 may be configured to transmit an XACK frame on the second link to STA 802 on detecting an error in an MPDU of PPDU 806. In another embodiment STA 804 may be configured to transmit an ACK frame (not shown in FIG. 8) over the first link (as shown in example 700) to STA 802 on detecting an error in an MPDU of PPDU 806. In example 800, STA 804 detects an error in an nth MPDU 812 of PPDU 806 and transmits an XACK frame 816 on the second link to STA 802 on detecting the error in the nth MPDU 812.

In an embodiment, on receiving XACK frame 816 on the second link (or on receiving an ACK frame over the first link as shown in example 700), STA 802 may either continue transmitting PPDU 806 until it is fully transmitted (e.g., until a last field, e.g., PE field, of PPDU 806 is transmitted) or may stop transmitting PPDU 806 as soon as possible (e.g., immediately after finishing the ongoing transmission of an MPDU subsequent to the nth MPDU 812 and, optionally, transmission of the PE field).

Next, immediately after finishing the transmission of PPDU 806 or stopping the transmission of PPDU 806, STA 802 transmits an extension 814 of PPDU 806 comprising the nth MPDU 812 received in error by STA 804. In an embodiment, the extension 814 of PPDU 806 is transmitted, like PPDU 806, on the first link. In an embodiment, as shown in FIG. 8, where PPDU 806 is fully transmitted before transmitting the extension, the extension 814 may be transmitted after a last field (e.g., PE field) of PPDU 806, without any interframe spacing between PPDU 806 and the extension 814. In another embodiment, where the transmission of PPDU 806 is stopped to transmit the extension, the extension 814 may be transmitted after a last transmitted MPDU of PPDU 806 (optionally, followed by a PE field), without any interframe spacing between the last transmitted MPDU of PPDU 806 (or optionally the PE following the last transmitted MPDU) and the extension 814.

In an embodiment, the extension 814 comprises a data field 818. The data field 818 includes the nth MPDU 812. In an embodiment, the data field 818 may include more than one MPDU signaled as received in error by STA 804. For example, STA 804 may transmit to STA 802 a further ACK/XACK frame (not shown in FIG. 8), while receiving PPDU 806, indicating another MPDU (not shown in FIG. 8) received in error by STA 804. STA 802 may accordingly include in the data field 818 of the extension 814 both the nth MPDU 812 and the other MPDU received in error.

In an embodiment, as shown in FIG. 8, the extension 814 may comprise one or more signaling (SIG) fields 820. The one or more SIG fields may comprise one or more of: a U-SIG, a UHR-SIG, a UHR-STF, one or more UHR-LTF, and a UHR-SIG 2 described above with reference to FIG. 3B.

The UHR-SIG allows STA 804 to determine the MCS used for data field 818 of the extension 814. Further, STA 804 may use indications in the UHR-SIG to locate the nth MPDU 812 in the data field 818 of the extension 814. The U- SIG allows STA 804 to determine the bandwidth of the extension 814 as well as the MCS used for the UHR-SIG.

STA 804 may use the UHR-STF and the one or more UHR-LTF to estimate channel coefficients in order to equalize the channel response (e.g., amplitude and phase distortion) while receiving the data field 818 of the extension 814.

As mentioned above, the UHR-SIG 2 contains indications for MU-MIMO applications. The UHR-SIG 2 field may also be used for other indications related to data field 818, e.g., MCS, data type, length, etc.

In an embodiment, as shown in FIG. 8, the extension 814 does not comprises a PHY preamble (before the one or more SIG fields 820). Alternatively or additionally, the extension 814 may also not comprise legacy signaling fields (e.g., L-STF, L-LTF, L-SIG, and RL-SIG). Additionally, some of the SIG fields 820 (e.g., UHR-SIG 2, UHR-STF, and UHR-LTF) may be omitted. As such, the transmission of the nth MPDU 812 using the extension 814 can be completed in a shorter time than the transmission of the nth MPDU 812 in a PPDU subsequent to PPDU 806. This improves the latency for the nth MPDU 812, which is advantageous particularly when the nth MPDU 812 is associated with latency sensitive traffic.

In an embodiment, before or after the transmission of PPDU 806, STAs 802 and 804 may exchange capability information regarding support of the above-described operation. For example, in an embodiment, XACK frame 816 may comprise an indication of whether STA 804 is capable of receiving a PPDU extension, such as extension 814. In another embodiment, XACK frame 816 may additionally comprise an indication of whether STA 804 wishes to receive PPDU extensions from STA 802.

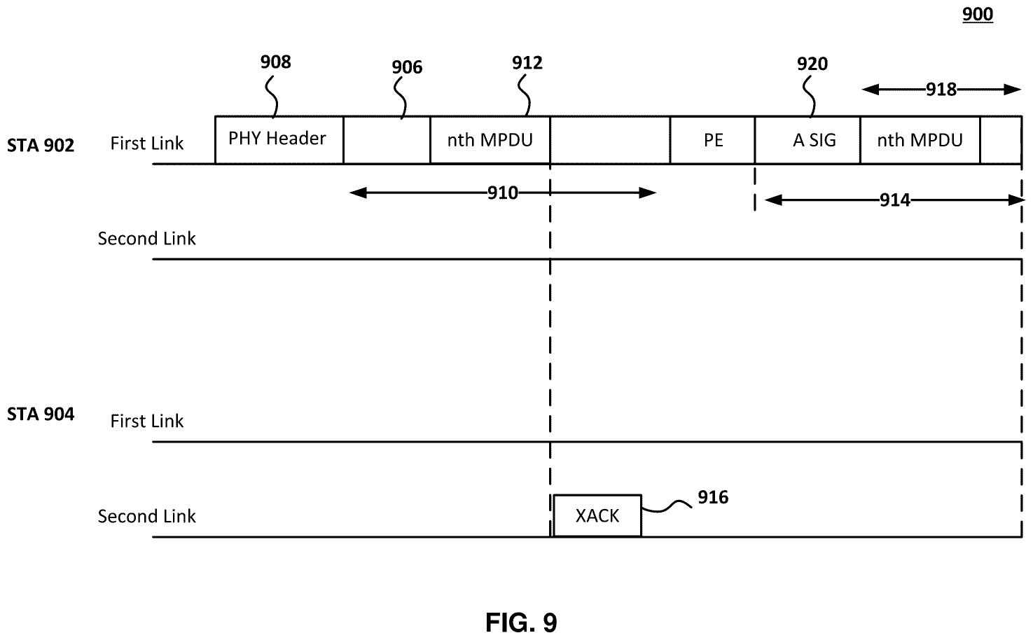

FIG. 9 illustrates an example 900 that illustrates an example operation according to an embodiment. As shown in FIG. 9, example 900 includes a STA 902 and a STA 904. STAs 902 and 904 may be communicatively coupled by a first link and a second link. The first and second links may correspond to different frequency bands (e.g., 2.4 GHz, 5 GHz, 60 GHz, etc.). STAs 902 and 904 may each comprise a STA or an AP.

In example 900, STA 902 is transmitting a PPDU 906 to STA 904. PPDU 906 may include a preamble (not shown in FIG. 9), a PHY header 908, a data field 910, and optionally a PE field. PPDU 906 may be, for example, an EHT PPDU as illustrated by example PPDU 300A or a UHR PPDU as illustrated by example PPDU 300B described above.

STA 904 may receive PPDU 906 over the first link and may first decode PHY header 908 of PPDU 906. In an embodiment, STA 904 may be configured to transmit an XACK frame on the second link to STA 902 on detecting an error in an MPDU of PPDU 906. In another embodiment, STA 904 may be configured to transmit an ACK frame (not shown in FIG. 9) over the first link (as shown in example 700) to STA 902 on detecting an error in an MPDU of PPDU 906. In example 900, STA 904 detects an error in an nth MPDU 912 of PPDU 906 and transmits an XACK frame 916 on the second link to STA 902 on detecting the error in the nth MPDU 912.

In an embodiment, on receiving XACK frame 916 on the second link (or on receiving an ACK frame over the first link as shown in example 700), STA 902 may either continue transmitting PPDU 906 until it is fully transmitted (e.g., until a last field, e.g., PE field, of PPDU 906 is transmitted) or may stop transmitting PPDU 906 as soon as possible (e.g., immediately after finishing the ongoing transmission of an MPDU subsequent to the nth MPDU 912 and, optionally, transmission of the PE field).

Next, immediately after finishing the transmission of PPDU 906 or stopping the transmission of PPDU 906, STA 902 transmits an extension 914 of PPDU 906 comprising the nth MPDU 912 received in error by STA 904. In an embodiment, the extension 914 of PPDU 906 is transmitted, like PPDU 906, on the first link. In an embodiment, as shown in FIG. 9, where PPDU 906 is fully transmitted before transmitting the extension, the extension 914 may be transmitted after a last field (e.g., PE field) of PPDU 906, without any interframe spacing between PPDU 906 and the extension 914. In another embodiment, where the transmission of PPDU 906 is stopped to transmit the extension, the extension 914 may be transmitted after a last transmitted MPDU of PPDU 906 (optionally, followed by a PE field), without any interframe spacing between the last transmitted MPDU of PPDU 906 and the extension 914.

In an embodiment, the extension 914 comprises a data field 918. The data field 918 includes the nth MPDU 912. In an embodiment, the data field 918 may include more than one MPDU signaled as received in error by STA 904. For example, STA 904 may transmit to STA 902 a further ACK/XACK frame (not shown in FIG. 9), while receiving PPDU 906, indicating another MPDU (not shown in FIG. 9) received in error by STA 904. STA 902 may accordingly include in the data field 918 of the extension 914 both the nth MPDU 912 and the other MPDU received in error.

In an embodiment, as shown in FIG. 9, the extension 914 may comprise an aggregated signal field (A-SIG) 920. A-SIG 920 may contain indications (e.g., MCS) regarding the data field 918 contained in the extension 914. A-SIG 920 may further comprise indications that allow STA 904 to locate the nth MPDU 912 in the data field 918 of the extension 914.

In an embodiment, as shown in FIG. 9, the extension 914 does not comprises a PHY preamble (before A-SIG 920). Alternatively or additionally, the extension 914 may also not comprise legacy signaling fields (e.g., L-STF, L-LTF, L-SIG, and RL-SIG). As such, the transmission of the nth MPDU 912 using the extension 914 can be completed in a shorter time than the transmission of the nth MPDU 912 in a PPDU subsequent to PPDU 906. This improves the latency for the nth MPDU 912, which is advantageous particularly when the nth MPDU 912 is associated with latency sensitive traffic.

In an embodiment, before or after the transmission of PPDU 906, STAs 902 and 904 may exchange capability information regarding support of the above-described operation. For example, in an embodiment, XACK frame 916 may comprise an indication of whether STA 904 is capable of receiving a PPDU extension, such as extension 914. In another embodiment, XACK frame 916 may additionally comprise an indication of whether STA 904 wishes to receive PPDU extensions from STA 902.

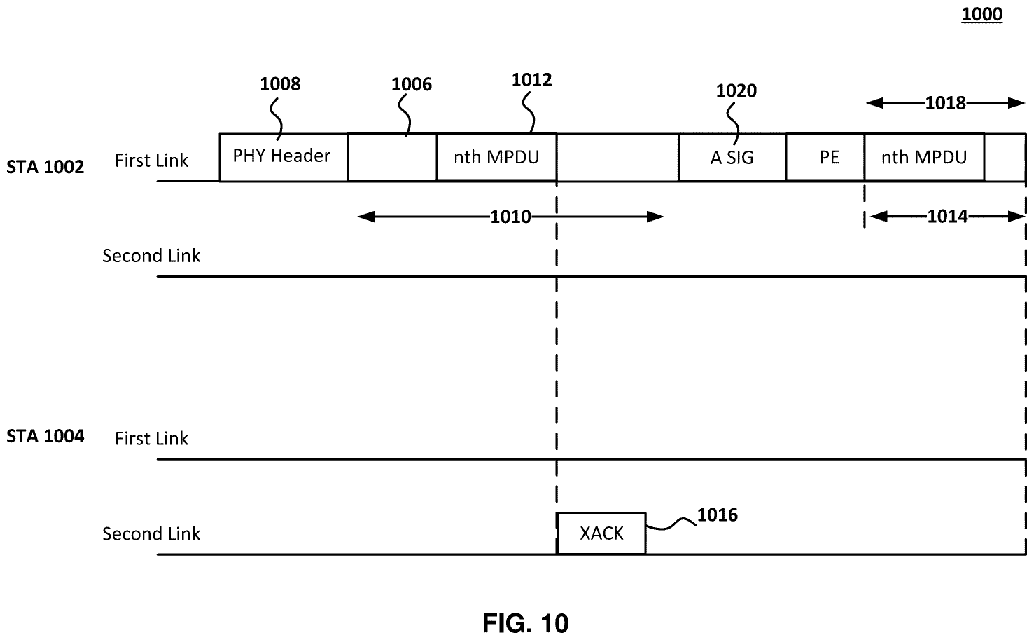

FIG. 10 illustrates an example 1000 that illustrates an example operation according to an embodiment. As shown in FIG. 10, example 1000 includes a STA 1002 and a STA 1004. STAs 1002 and 1004 may be communicatively coupled by a first link and a second link. The first and second links may correspond to different frequency bands (e.g., 2.4 GHz, 5 GHz, 60 GHz, etc.). STAs 1002 and 1004 may each comprise a STA or an AP.

In example 1000, STA 1002 is transmitting a PPDU 1006 to STA 1004. PPDU 1006 may include a preamble (not shown in FIG. 10), a PHY header 1008, a data field 1010, and, optionally, an A-SIG 1020 and/or a PE field. PPDU 1006 may be, for example, an EHT PPDU as illustrated by example PPDU 300A or a UHR PPDU as illustrated by example PPDU 300B described above.

STA 1004 may receive PPDU 1006 over the first link and may first decode PHY header 1008 of PPDU 1006. In an embodiment, STA 1004 may be configured to transmit an XACK frame on the second link to STA 1002 on detecting an error in an MPDU of PPDU 1006. In another embodiment, STA 1004 may be configured to transmit an ACK frame (not shown in FIG. 10) over the first link (as shown in example 700) to STA 1002 on detecting an error in an MPDU of PPDU 1006. In example 1000, STA 1004 detects an error in an nth MPDU 1012 of PPDU 1006 and transmits an XACK frame 1016 on the second link to STA 1002 on detecting the error in the nth MPDU 1012.

In an embodiment, on receiving XACK frame 1016 on the second link (or on receiving an ACK frame over the first link as shown in example 700), STA 1002 may either continue transmitting PPDU 1006 until it is fully transmitted (e.g., until a last field, e.g., a PE field of PPDU 1006 is transmitted) or may stop transmitting PPDU 1006 as soon as possible (e.g., immediately after finishing the ongoing transmission of an MPDU subsequent to the nth MPDU 1012 and, optionally, transmission of the PE field).

Next, immediately after finishing the transmission of PPDU 1006 or stopping the transmission of PPDU 1006, STA 1002 transmits an extension 1014 of PPDU 1006 comprising the nth MPDU 1012 received in error by STA 1004. In an embodiment, the extension 1014 of PPDU 1006 is transmitted, like PPDU 1006, on the first link. In an embodiment, as shown in FIG. 10, where PPDU 1006 is fully transmitted before transmitting the extension, the extension 1014 may be transmitted after a last field (e.g., PE field) of PPDU 1006, without any interframe spacing between PPDU 1006 and the extension 1014. In another embodiment, where the transmission of PPDU 1006 is stopped to transmit the extension, the extension 1014 may be transmitted after a last transmitted MPDU of PPDU 1006 (optionally, followed by a PE field), without any interframe spacing between the last transmitted MPDU of PPDU 1006 and the extension 1014.

In an embodiment, the extension 1014 comprises a data field 1018. The data field 1018 includes the nth MPDU 1012. In an embodiment, the data field 1018 may include more than one MPDU signaled as received in error by STA 1004. For example, STA 1004 may transmit to STA 1002 a further ACK/XACK frame (not shown in FIG. 10), while receiving PPDU 1006, indicating another MPDU (not shown in FIG. 10) received in error by STA 1004. STA 1002 may accordingly include in the data field 1018 of the extension 1014 both the nth MPDU 1012 and the other MPDU received in error.

In an embodiment, as shown in FIG. 10, PPDU 1006 may comprise A-SIG 1020. A-SIG 1020 may follow a last transmitted MPDU of PPDU 1006 (regardless of whether all MPDUs of PPDU 1006 are transmitted or not). The presence of A-SIG 1020 in PPDU 1006 indicates to STA 1004 the upcoming transmission of the extension 1014. As such, STA 1004 may continue monitoring/listening/receiving on the first link to receive the extension 1014 from STA 1002.

In an embodiment, as described above, A-SIG 1020 may also contain indications (e.g., MCS) regarding the data field 1018 contained in the extension 1014. A-SIG 1020 may further comprise indications that allow STA 1004 to locate the nth MPDU 1012 in the data field 1018 of the extension 1014.

In an embodiment, as shown in FIG. 10, the extension 1014 does not comprises a PHY preamble. Alternatively or additionally, the extension 1014 may also not comprise legacy signaling fields (e.g., L-STF, L-LTF, L-SIG, and RL-SIG). In an embodiment, the extension 1014 comprises only MPDUs, without any signaling fields. As such, the transmission of the nth MPDU 1012 using the extension 1014 can be completed in a shorter time than the transmission of the nth MPDU 1012 in a PPDU subsequent to PPDU 1006. This improves the latency for the nth MPDU 1012, which is advantageous particularly when the nth MPDU 1012 is associated with latency sensitive traffic.

In an embodiment, before or after the transmission of PPDU 1006, STAs 1002 and 1004 may exchange capability information regarding support of the above-described operation. For example, in an embodiment, XACK frame 1016 may comprise an indication of whether STA 1004 is capable of receiving a PPDU extension, such as extension 1014. In another embodiment, XACK frame 1016 may additionally comprise an indication of whether STA 1004 wishes to receive PPDU extensions from STA 1002.

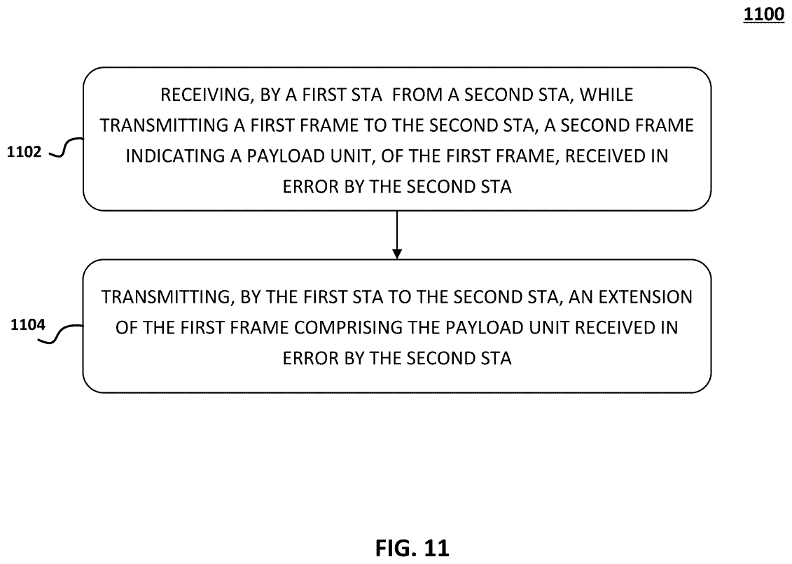

FIG. 11 illustrates an example process 1100 according to an embodiment. Example process 1100 is provided for the purpose of illustration only and is not limiting embodiments. Process 1100 may be performed by a first STA (e.g., non-AP STA or AP STA) while communicating with a second STA (e.g., non-AP STA or AP STA). The first STA and the second STA may be communicatively coupled by a first link and a second link (e.g., 2.4 GHz, 5 GHz, 6 GHz, 60 GHz, etc.)

As shown in FIG. 11, process 1100 begins in step 1102, which includes receiving, by the first STA from the second STA, while transmitting a first frame to the second STA, a second frame indicating a payload unit, of the first frame, received in error by the second STA.

In an embodiment, the first frame comprises a PPDU and the payload unit comprises an MPDU.

In an embodiment, the second frame comprises an acknowledgment frame. The acknowledgment frame may comprise a BA frame, a NACK frame, a multi-station (multi-STA) BA frame, or an XACK frame.

In an embodiment, the first frame is transmitted via the first link between the first STA and the second STA, and the second frame is received via the first link or the second link.

In step 1104, process 1100 includes transmitting, by the first STA to the second STA, an extension of the first frame comprising the payload unit received in error by the second STA. In an embodiment, the first frame and the extension may be transmitted via the first link between the first STA and the second STA.

In an embodiment, the extension is transmitted after a last field of the first frame, without an interframe spacing between the first frame and the extension.

In an embodiment, the extension of the first frame does not comprise a PHY preamble.

In an embodiment, the last field of the first frame comprises a PE field. In an embodiment, the first frame comprises an A-SIG.

In an embodiment, the extension of the first frame comprises one or more signaling fields, including one or more of: a U-SIG, a UHR-SIG, a UHR-STF, a UHR-LTF, and a UHR-SIG 2.

In another embodiment, the extension of the first frame comprises an A-SIG.

In an embodiment, the second frame is received before an end of transmission of the first frame.

In an embodiment, the second frame comprises an indication of whether the second STA is capable of receiving the extension of the first frame.

In an embodiment, the second frame comprises an indication of whether the second STA wishes to receive the extension of the first frame.

In an embodiment, process 1100 further comprises receiving, by the first STA from the second STA, while transmitting the first frame to the second STA, a third frame indicating an error in a second payload unit of the first frame. In an embodiment, the extension of the first frame comprises the first and second payload units.

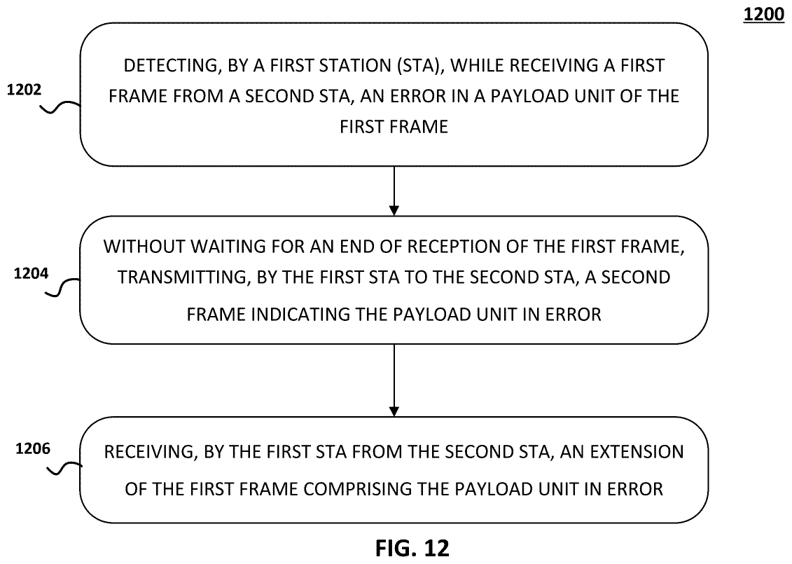

FIG. 12 illustrates an example process 1200 according to an embodiment. Example process 1200 is provided for the purpose of illustration only and is not limiting embodiments. Process 1200 may be performed by a first STA (e.g., non-AP STA or AP STA) communicating with a second STA (e.g., non-AP STA or AP STA). The first STA and the second STA may be communicatively coupled by a first link and a second link (e.g., 2.4 GHz, 5 GHz, 6 GHz, 60 GHz, etc.).

As shown in FIG. 12, process 1200 begins in step 1202, which includes detecting, by the first STA, while receiving a first frame from the second STA, an error in a payload unit of the first frame.

In an embodiment, the first frame comprises a PPDU. In an embodiment, the payload unit comprises an MPDU. In an embodiment, the error in the payload unit of the first frame corresponds to an error in an FCS associated with the MPDU.

Step 1204 includes transmitting, by the first STA to the second STA, a second frame indicating the payload unit in error, without waiting for an end of reception of the first frame.

In an embodiment, transmitting the second frame comprises transmitting the second frame before an end of reception of a subsequent MPDU of the PPDU.

In an embodiment, the second frame comprises an acknowledgment frame. In an embodiment, the acknowledgment frame comprises a block acknowledgment (BA) frame, a negative acknowledgment (NACK) frame, a multi-station (multi-STA) BA frame, or a cross-link acknowledgment (XACK) frame.

In an embodiment, the first frame is received via the first link between the first STA and the second STA, and the second frame is transmitted via the first link or the second link.

In an embodiment, the first frame comprises an A-SIG.

Step 1206 includes receiving by the first STA from the second STA, an extension of the first frame comprising the payload unit in error.

In an embodiment, the first frame and the extension are received via the first link between the first STA and the second STA. In an embodiment, the extension is received after a last field of the first frame, without an interframe spacing between the first frame and the extension. In an embodiment, the last field of the first frame comprises a PE field.

In an embodiment, the extension of the first frame comprises a PE field. In an embodiment, the PE field of the extension of the first frame indicates the extension to the second STA.

In embodiment, the extension of the first frame does not comprise a PHY preamble.

In an embodiment, the extension of the first frame comprises one or more signaling fields, including one or more of: a U-SIG, a UHR-SIG, a UHR-STF, a UHR-LTF, and a UHR-SIG 2.

In an embodiment, the extension of the first frame comprises an A-SIG.

In an embodiment, the second frame is transmitted before the end of reception of the first frame.

In an embodiment, process 1200 further comprises transmitting, by the first STA to the second STA, while receiving the first frame from the second STA, a third frame indicating an error in a second payload unit of the first frame. In an embodiment, the extension of the first frame comprises the first and second payload units.

In an embodiment, the second frame comprises an indication of whether the second STA is capable of receiving the extension of the first frame.

In an embodiment, the second frame comprises an indication of whether the second STA wishes to receive the extension of the first frame.

What is claimed is:

1. A first station (STA) comprising:
one or more processors; and
memory storing instructions that, when executed by the one or more processors, cause the first STA to:
receive, from a second STA while transmitting a first frame to the second STA, a second frame indicating a payload unit, of the first frame, received in error by the second STA; and
transmit, to the second STA, an extension of the first frame comprising the payload unit received in error by the second STA.

2. The first STA of claim 1, wherein the first frame comprises a physical layer protocol data unit (PPDU), wherein the payload unit comprises a medium access control (MAC) protocol data unit (MPDU), and wherein the second frame comprises an acknowledgment frame.

3. The first STA of claim 1, wherein the first frame and the extension are transmitted via a first link between the first STA and the second STA.

4. The first STA of claim 3, wherein the extension is transmitted after a last field of the first frame, without an interframe spacing between the first frame and the extension.

5. The first STA of claim 4, wherein the last field of the first frame comprises a packet extension (PE) field.

6. The first STA of claim 1, wherein the extension of the first frame comprises an aggregated signal field (A-SIG) and a signaling field, and wherein the signaling field comprises one or more of:
a Universal Signal field (U-SIG),
an ultra-high reliability (UHR) Signal Field (UHR-SIG),
an UHR Short Training Field (UHR-STF) field,
a UHR Long Training field (UHR-LTF), and
a UHR Signal Field 2 (UHR-SIG 2).

7. The first STA of claim 1, wherein the extension of the first frame comprises a packet extension (PE) field, and wherein the PE field indicates the extension to the second STA.

8. A first station (STA) comprising:
one or more processors; and
memory storing instructions that, when executed by the one or more processors, cause the first STA to:
detect, while receiving a first frame from a second STA, an error in a payload unit of the first frame;
without waiting for an end of reception of the first frame, transmit, to the second STA, a second frame indicating the payload unit in error; and
receive, from the second STA, an extension of the first frame comprising the payload unit in error.

9. The first STA of claim 8, wherein the first frame comprises a physical layer protocol data unit (PPDU), wherein the payload unit comprises a medium access control (MAC) protocol data unit (MPDU), and wherein the error in the payload unit of the first frame corresponds to an error in a Frame Check Sequence (FCS) associated with the MPDU.

10. The first STA of claim 9, wherein transmitting the second frame comprises transmitting the second frame before an end of reception of a subsequent MPDU of the PPDU.

11. The first STA of claim 8, wherein the first frame and the extension of the first frame are received via a first link between the first STA and the second STA.

12. The first STA of claim 11, wherein the extension is received after a last field of the first frame, without an interframe spacing between the first frame and the extension.

13. The first STA of claim 8, wherein the extension of the first frame comprises an aggregated signal field (A-SIG) and a signaling field, and wherein the signaling field comprises one or more of:
a Universal Signal field (U-SIG),
an UHR Signal Field (UHR-SIG),
an UHR Short Training Field (UHR-STF) field,
a UHR Long Training field (UHR-LTF), and
a UHR Signal Field 2 (UHR-SIG 2).

14. The first STA of claim 8, wherein the extension of the first frame comprises a packet extension (PE) field, and wherein the PE field indicates the extension to the second STA.

15. A non-transitory computer-readable medium comprising instructions that, when executed by one or more processors of a first station (STA), cause the first STA to:
receive, from a second STA while transmitting a first frame to the second STA, a second frame indicating a payload unit, of the first frame, received in error by the second STA; and
transmit, to the second STA, an extension of the first frame comprising the payload unit received in error by the second STA.

16. The non-transitory computer-readable medium of claim 15, wherein the first frame comprises a physical layer protocol data unit (PPDU), wherein the payload unit comprises a medium access control (MAC) protocol data unit (MPDU), and wherein the second frame comprises an acknowledgment frame.

17. The non-transitory computer-readable medium of claim 15, wherein the extension is transmitted after a last field of the first frame, without an interframe spacing between the first frame and the extension.

18. The non-transitory computer-readable medium of claim 17, wherein the last field of the first frame comprises a packet extension (PE) field.

19. The non-transitory computer-readable medium of claim 15, wherein the extension of the first frame comprises an aggregated signal field (A-SIG) and a signaling field, and wherein the signaling field comprises one or more of:
a Universal Signal field (U-SIG),
an UHR Signal Field (UHR-SIG),
an UHR Short Training Field (UHR-STF) field,
a UHR Long Training field (UHR-LTF), and
a UHR Signal Field 2 (UHR-SIG 2).

20. The non-transitory computer-readable medium of claim 15, wherein the extension of the first frame comprises a packet extension (PE) field, and wherein the PE field indicates the extension to the second STA.
